(19) United States
(12) Patent Application Publication
(10) Pub. No.: US 2008/0022515 A1
(43) Pub. Date: Jan. 31, 2008

(54) MANAGEMENT SYSTEM FOR FEEDERS OF SURFACE MOUNTING EQUIPMENT

(75) Inventors: TSUNG-CHIH TSAI, Tu-Cheng (TW); CHUN-GUANG ZHAO, Shenzhen (CN); WEI ZHANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,647

(22) Filed: Dec. 1, 2006

(30) Foreign Application Priority Data
Jul. 26, 2006 (CN) 200610061808.6

(51) Int. Cl. B23P 19/00

(52) U.S. Cl. 29/739; 29/709

(57) ABSTRACT

In one preferred embodiment, a management system is used for facilitating choosing components arranged on a variety of feeders of a surface mounting equipment. The management system comprises a plurality of storage integrated circuit (IC) cards. Each of the storage IC cards is mounted to a corresponding feeder. Each of the storage IC cards stores information about the corresponding feeder and the components arranged on the corresponding feeder. A controlling device is electrically connected to the storage IC cards for reading the information of the storage IC cards to identify the electronic components mounted on one of the feeders in response to a demand signal provided by the surface mounting equipment. The controlling device is capable of sending a feedback signal to the surface mounting equipment according to the read information and controls a pick-up arm of the surface mounting equipment to pick up components of a selected feeder.

### BACKGROUND OF THE INVENTION

1. Field of the Invention

The present invention relates to surface mounting equipment, and more particularly to a management system for feeders of the surface mounting equipment.

2. Description of Related Art

A variety of surface mounting equipment have been proposed for mounting small components such as resistors, capacitors or integrated circuits on a substrate such as a printed circuit board (PCB). A surface mounting equipment is disclosed in CN Pub. No. 00122236.8. The PCB is conveyed along a conveyer in a path to a mounting station, feeders of the surface mounting equipment are at one or two sides of the path and supply a variety of components. A controlling device controls a mounting head to pick up the components from a selected feeder, and place the components on the PCB.

Different feeders supply different components, thus, during a process of mounting surface components, the surface mounting equipment identifies the feeders to select the corresponding feeder. Usually, bar codes are arranged on machine feeders for identification.

However, information of the bar codes is limited. Sometimes, using the bar code to manage the feeders is not sufficient.

What is desired, therefore, is a management system which provides effective management of feeders of surface mounting equipment.

### SUMMARY OF THE INVENTION

In one preferred embodiment, a management system is used for facilitating choosing components arranged on a variety of feeders of a surface mounting equipment. The management system comprises a plurality of storage integrated circuit (IC) cards. Each of the storage IC cards is mounted to a corresponding feeder. Each of the storage IC cards stores information about the corresponding feeder and the components arranged on the corresponding feeder. A controlling device is electrically connected to the storage IC cards for reading the information of the storage IC cards to identify the electronic components mounted on one of the feeders in response to a demand signal provided by the surface mounting equipment. The controlling device is capable of sending a feedback signal to the surface mounting equipment according to the read information and controls a pick-up arm of the surface mounting equipment to pick up components of a selected feeder.

Other advantages and novel features will become more apparent from the following detailed description of preferred embodiments when taken in conjunction with the accompanying drawings, in which:

### BRIEF DESCRIPTION OF THE DRAWINGS

FIG. 1 is a block diagram of a management system for feeders of surface mounting equipment in accordance with a preferred embodiment of the present invention, together with a machine, the management system includes a data storage card, a connecting device, and a controlling device;

FIG. 2 is an exploded, isometric view of the data storage card and the connecting device of FIG. 1, together with a feeder and a fixing device; and

FIG. 3 is an enlarged view of the data storage card and the fixing device of FIG. 2, but viewed from another aspect and showing the fixing device in an open state.

### DETAILED DESCRIPTION OF THE INVENTION

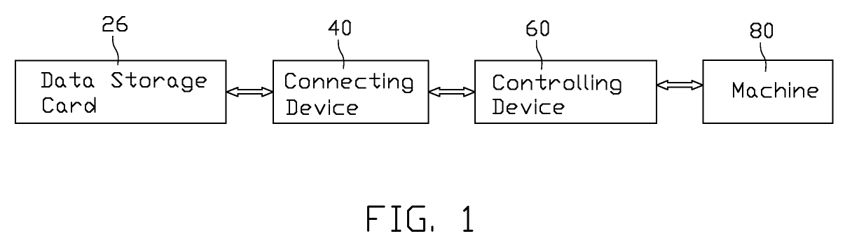

As shown in FIG. 1 to FIG. 3, in a preferred embodiment of the present invention, a management system for machine feeders of surface mounting equipment includes a plurality of feeders 10 (only one shown), a plurality of fixing devices 20 respectively mounted on the feeders 10, a plurality of data storage card 26 for storing information about the feeder 10, a connecting device 40, and a controlling device 60. A plurality of types of small components, such as resistors, capacitors or integrated circuits, is respectively mounted on the feeders 10. The data storage device 26 is fixed in the fixing device 20. The fixing device 20 electrically connects to the controlling device 60 through the connecting device 40. The information about the feeder includes production information, maintenance information, using information, and so on. The feeder 10 is disclosed in a copending application Ser. No. 11/316,009, which is incorporate herewith.

The fixing device 20 includes a first printed circuit board (PCB) 22 mounted on the feeder 10, a card holder 24, and a plurality of stick-shaped conductors 28 soldered on the first PCB 22. In the embodiment, the data storage card 26 employs an integrated circuit (IC) made by Siemens Ltd and coded SLE4442. The data storage card 26 includes six ports. The six ports include a power port, a ground port, a data port, a clock port, a reset port, and an idle port. The card holder 24 includes a holding portion 242 for holding the data storage card 26, and a fixing portion 244 mounted on the first PCB 22. The fixing potion 244 forms six protrusions 246 corresponding to the six ports of the data storage card 26, and six pins 248 electrically connecting the protrusions 246 and the conductors 28 correspondingly.

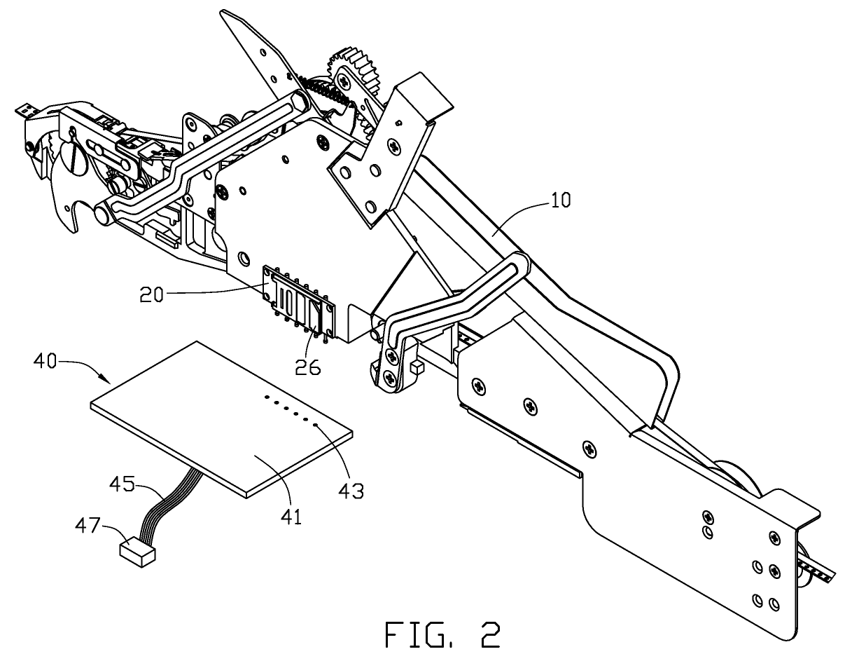

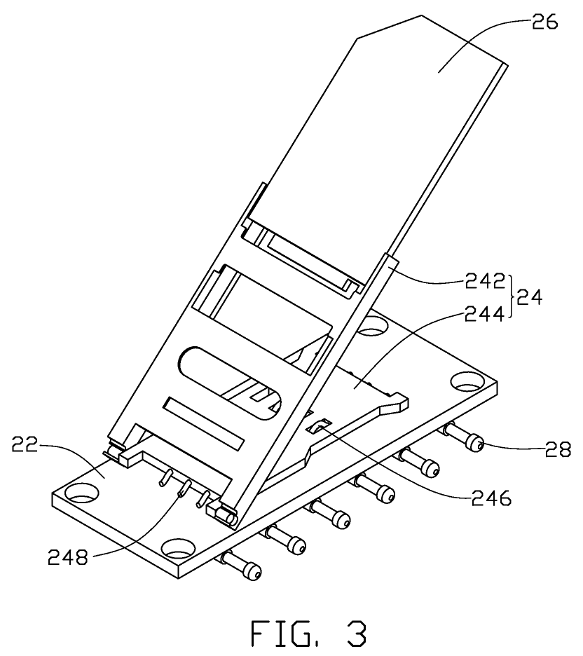

The connecting device 40 includes a second PCB 41, six conductive parts, such as six pads 43 formed on the second PCB 41 corresponding to the conductors 28 of the fixing device 20, a plurality of wires 45, and a connector 47 electrically connected to the controlling device 60 (not shown in FIG. 2 and FIG. 3). The connector 47 is electrically connected to the pad 43 though the wires 45 and traces of the second PCB 41.

The feeder 10 and the connecting device 40 are mounted on a surface mounting equipment. An end of each of the conductors 28 of the fixing device 20 touches the corresponding pad 43 of the connecting device 40. The data storage card 26 is received in the holding portion 242 of the card holder 24. The ports of the data storage card 26 are electrically connected to the protrusions 246 of the fixing portion 244 of the card holder 24 when the card holder 24 is closed. The connector 47 is connected to the controlling device 60. Thus, the data storage card 26 is electrically connected to the controlling device 60 through the protrusions 246 of the card holder 24, pins 248 of the card holder 24, conductors 28, the wires 45 and the connector 47.

In operation, a machine 80 of the surface mounting equipment sends a demand signal about demanded components to the controlling device 60, the controlling device 60 reads the information of the data storage card 26 to identify a corresponding feeder 10 having the demanded components. The controlling device 60 sends a feedback signal to the machine 80. The machine 80 picks up the demanded components from the corresponding feeder 10.

Alternatively, the conductive parts of the connecting device 40 may employ soft electric materials, such as conductive cotton or conductive rubber. The conductors 28 of the fixing device 20 may be directly electrically connected to the connector 47 through a plurality of wires. The six ports of the data storage card 26 may be directly electrically connected to the connector 47 though a plurality of wires. The data storage card 26 may be mounted on the feeder 10 by other methods, for example, pasting the data storage card 26 to the feeder 10.

In the embodiment, the management system employs the data storage card 26 to store the information about the feeder 10 and the components mounted on the feeder 10. The data storage card 26 has a larger capacity for information than a bar code employed by a typical feeder management system. Thus, the management system of the present invention may store more information than typical feeder management systems do. Additionally, the data storage card 26 can not only read but also be written to. Furthermore, some cards having secrecy functions may be employed as the data storage card 26. Thus, the management system provides effective management of feeders of the surface mounting equipment.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A management system for components feeding of surface mounting equipment, the management system comprising:
a plurality of storage integrated circuit (IC) cards, each of the storage IC cards configured for being mounted on a corresponding feeder, each of the storage IC cards storing information about the corresponding feeder; and
a controlling device electrically connected to the storage IC cards for reading the information in the storage IC cards to identify the components mounted on one of the feeders in response to a demand signal provided by the surface mounting equipment, the controlling device sending a feedback signal to the surface mounting equipment according to the read information and controlling a pick-up arm of the surface mounting equipment to pick up the identified components from a corresponding feeder.

2. The management system as claimed in claim 1, wherein the card has a plurality of ports electrically connected to the controlling device through a plurality of wires and a connector.

3. The management system as claimed in claim 1, further comprising a plurality of fixing devices, each of the fixing devices configured for holding a corresponding storage IC card and being mounted on a corresponding feeder, the fixing device comprising protrusions electrically connected to ports of the corresponding storage IC card, conductors electrically connected to the controlling device, and pins connecting the protrusions to the conductors.

4. The management system as claimed in claim 3, further comprising a connecting device, the connecting device forming conductive parts touching the conductors of the fixing device, the conductive parts being electrically connected to the controlling device through a plurality of wires and a connector.

5. The management system as claimed in claim 4, wherein the connecting device further comprises a printed circuit board (PCB), the conductive parts are pads defined on the PCB.

6. The management system as claimed in claim 4, wherein the conductive parts are made of soft conductive material.

7. The management system as claimed in claim 6, wherein the conductive parts are made of conductive cotton.

8. The management system as claimed in claim 6, wherein the conductive parts are made of conductive rubber.

9. An assembly, comprising:
a surface mounting equipment providing a pick-up arm;
a plurality of feeders each providing a plurality of components, each of the feeders having a storage integrated circuit (IC) card storing information of the components mounted thereon; and
a controlling device electrically connected to the storage IC cards for reading the information in the storage IC cards to identify the components mounted on one of the feeders in response to a demand signal provided by the surface mounting equipment, and sending a feedback signal to the surface mounting equipment according to the read information and controlling the pick-up arm to pick up the identified components from the corresponding feeder.

10. The assembly as claimed in claim 9, wherein the card has a plurality of ports electrically connected to the controlling device through a plurality of wires and a connector.

11. The assembly as claimed in claim 9, further comprising a plurality of fixing devices, each of the fixing devices configured for holding a corresponding storage IC card and being mounted on a corresponding feeder, the fixing device comprising protrusions electrically connected to ports of the corresponding storage IC card, conductors electrically connected to the controlling device, and pins electrically connecting the protrusions to the conductors.

12. The assembly as claimed in claim 11, wherein each of the fixing devices comprises a card holder which comprises a holding portion for holding a corresponding storage IC card thereto, and a fixing portion secured with respect to a corresponding feeder, the holding portion being pivotably connected to the fixing portion.

13. The assembly as claimed in claim 11, further comprising a connecting device, the connecting device forming conductive parts touching the conductors of the fixing device, the conductive parts being electrically connected to the controlling device through a plurality of wires and a connector.

14. The assembly as claimed in claim 13, wherein the connecting device further comprises a printed circuit board (PCB), and the conductive parts are pads defined on the PCB.

15. The assembly as claimed in claim 13, wherein the conductive parts are made of soft conductive material.

16. The assembly as claimed in claim 15, wherein the conductive parts are made of conductive cotton.

17. The assembly as claimed in claim 15, wherein the conductive parts are made of conductive rubber.

18. The assembly as claimed in claim 9, wherein each of the storage IC cards store information of the corresponding feeder on which the storage IC card is mounted.
